(19) United States
(12) Patent Application Publication
(10) Pub. No.: US 2015/0351412 A1
(43) Pub. Date: Dec. 10, 2015

(54) Method and Apparatus for Forming Elongate, Strip-Shaped Bodies and for Producing Baked Products

(71) Applicant: HAAS, FOOD EQUIPMENT GMBH, Wien (AT)

(72) Inventors: JOHANNES HAAS, WIEN (AT); JOSEF HAAS, LEOBENDORF (AT); CHRISTOPH JIRASCHEK, FREDERIKSBERG (DK); STEFAN JIRASCHEK, KOENIGSBRUNN (AT)

(21) Appl. No.: 14/760,889

(22) PCT Filed: Jan. 14, 2014
(86) PCT No.: PCT/EP2014/050608

§ 371 Date: Jul. 14, 2015

(30) Foreign Application Priority Data
Jan. 15, 2013 (AT) A29/2013

(51) Int. Cl. A21C 9/08; A21D 8/02; A21B 7/00

(52) U.S. Cl. CPC A21C 9/085; A21B 7/005; A21D 8/02

(57) ABSTRACT

Apparatus, arrangement, baking system and method for forming elongate strip-shaped bodies of a pumpable mass which is sensitive to shear forces for forming baked products. A pump apparatus conveys the mass into a pump outlet region. A dividing section is located downstream of the pump outlet region in the flow direction. A plurality of dividing openings delimited by dividing elements are provided in the dividing section. A plurality of separate dividing channels lead from the dividing openings as far as the mass outlet openings. A moving transport surface transports the strip-shaped bodies emerging from the mass outlet openings. The dividing channels comprise a continuously running-together reducing region and the mass outlet openings are spaced apart from one another in the transverse direction of the transport surface.

The invention relates to an apparatus and a method for forming elongate, strip-shaped bodies from a pumpable mass which is sensitive to shear forces, which are baked in a baking oven to form baked products. The invention further relates to an arrangement of a plurality of apparatuses according to the invention and a baking system comprising an apparatus according to the invention and/or an arrangement according to the invention. The invention relates to the manufacture of elongate strip-shaped bodies from a pumpable mass which is sensitive to shear forces to form baked products comprising the following steps: the mass is conveyed by a pump apparatus into a pump outlet region where the volume flow of the mass in the pump outlet region has a velocity profile and the volume flow of the mass is then divided in a dividing region into a plurality of partial volume flows.

Apparatuses for forming elongate strip-shaped bodies for producing edible products have been known for a long time and can be deduced from the prior art.

For example, for the production of dough products such as, for example, elongate noodles, apparatuses are known in which a pump apparatus compacts a solid noodle dough and pumps it into a tubular body. At the end of this tubular body substantially planar disks with openings are provided, where the openings correspond to the cross-sectional shape of the noodle products to be extruded. The openings have sharp edges in order to cut the noodle bodies to be extruded away from the dough. The noodle strands thus formed are subsequently cut to length and dried, where the consistency of the noodle dough is already relatively dry and firm before drying so that there is no risk of the individual noodle strands sticking together.

In order to form thin elongate baked products such as, for example salt sticks, bread sticks, puff pastry sticks etc. apparatuses are known in which the dough is guided into a buffer storage device under pressure. A plurality of channels emanate from this buffer storage device which are adapted to form elongate dough strands. Subsequently the output dough strands are placed onto a moving transport belt in order to be conveyed, for example, to a cutting apparatus and further to a baking oven. At the outlet of the dough strands it is absolutely essential that all the dough strands have the same outlet velocity which is in an exact relationship to the conveying speed of the conveyor belt. The reason for this is that speed differences of individual dough strands would cause a stretching or compression of this dough strand.

In the industrial production of baked products, uniform quality is of major importance. Even the slightest speed differences at the outlet from the apparatus for forming elongate strip-shaped bodies would adversely affect the quality of the baked product.

For this purpose apparatuses can be deduced from the prior art in which the friction and therefore the outlet velocity in each outlet channel can be adjusted individually by adjusting elements. A disadvantage of this construction is that this adjustment must be different depending on the viscosity of the dough. In the case of a modification of the baking recipe or in the case of small fluctuations of the dough composition, it therefore arises that the speed adjustment of the channels must be performed anew.

Apparatuses for forming dough strands are also known from the prior art in which dough is scraped from a relatively large fluted roller by means of a scraper and guided into an elongate gap. Channels for forming individual dough strands are disposed adjacent to one another along this gap. However, the provision of these fluted rollers which extend over the entire width of the systems is very expensive. In addition, different flow conditions occur in particular in the edge regions of the gaps which subsequently results in different outlet velocities and in an adverse effect on the quality.

Another factor which influences the quality of the baked products and the elongate strip-shaped bodies is the sensitivity of the mass to shear forces. The mass, e.g. the dough is firstly conveyed through a larger pump outlet cross-section from the pump and then into a smaller outlet cross-section to form the elongate bodies. If this reduction is accomplished for example around sharp edges as is known in noodle production, a change in the consistency of the dough takes place due to the high shear forces. This leads to a deterioration in the quality in masses to form baked products.

The effects are even stronger when different dough strands of different openings are exposed to different shear forces. If, for example, one dough strand is reduced substantially along a straight axis and another is deflected around a plurality of edges, the consistency of the one dough strand differs from the consistency of the other dough strand. Furthermore, as a result of the different deflection, the friction in the channels is different, which in turn results in different outlet velocities.

In order to form elongate strip-shaped bodies which are subsequently intended to pass through a baking process, the dough strands, i.e. the bodies must be placed adjacent to one another on a transport surface. According to the prior art, to this end the channels to form the dough strands are configured in the form of bores in such a manner that all the outlet openings lie in a row adjacent to one another. From there the dough strands then extend onto a conveyor belt.

Since elongate strip-shaped bodies to form baked products have a consistency which can be designated as softly sticky to doughy, it is extremely important that at the outlet the individual dough strands are placed separately from one another on the conveying surface.

There is therefore a conflict of aims for the industrial production of elongate strip-shaped bodies from pumpable masses which are sensitive to shear forces to form baked products since the channels for forming the dough strands must be designed to be substantially the same in order to avoid the problems of different shear forces and of different outlet velocity. On the other hand however, all the dough strands must be placed adjacent to one another on the flat conveying surface. Furthermore pumps should be used which are compact, reliable and simple in their construction. At the same time there should be a flexibility of the products to be produced. For example, rod-shaped or spiral products should be able to be produced according to requirements. Furthermore in industrial production, a high throughput with uniform quality is important.

It is now the object of the invention to overcome the disadvantages of the prior art and provide an apparatus for forming elongate strip-shaped bodies from pumpable masses which are sensitive to shear forces to form baked products, which is simple in structure, flexible in the use of the dough and maintenance-optimized and which allows the production of high-quality baked products with constant uniform quality.

The objects according to the invention are solved whereby the dividing channels comprise a continuously running-together reducing region and that the mass outlet openings in the transverse direction of the transport surface have a distance from one another and/or that all the partial volume flows are the same size, that the bodies are placed adjacent to one another at a distance on a moving transport surface and that the outlet velocities of all the emerging bodies are the same.

Further features according to the invention can be that the dividing elements are disposed substantially radially symmetrically and/or point-symmetrically about the centre of gravity of the cross-sectional area of the dividing region and/or that the dividing elements are disposed along the axes of symmetry of the cross-sectional area of the dividing region, that all the dividing openings in the dividing region have the same area content and/or are congruent, that the dividing elements are designed to be web-shaped and/or wedge-shaped, that the dividing elements comprise combs directed contrary to the direction of flow of the mass and/or that the combs are preferably designed to be rounded contrary to the direction of flow.

Furthermore, the invention is optionally characterized in that the dividing channels are designed to be substantially following the direction of flow of the mass in the pump outlet region and/or that the direction of flow of the mass in the mass outlet openings substantially corresponds to the direction of flow of the mass in the pump outlet region, that the pump apparatus is designed as an extruder, that the pump outlet region has a substantially circular cross-section or that rotary nozzles are provided in the region of the mass outlet openings or that the rotary nozzles comprise the mass outlet openings and/or that a planetary transmission is provided to drive the rotary nozzles of a group of mass outlet openings.

The arrangement according to the invention is characterized in that in the transverse direction of the transport surface a plurality of apparatuses according to the preceding description are arranged adjacent to one another.

The baking system according to the invention comprising a heated or heatable baking chamber for baking elongate strip-shaped bodies of a pumpable mass which is sensitive to shear forces, can be characterized in that an apparatus or an arrangement according to the preceding description is provided.

The method according to the invention for producing elongate strip-shaped bodies from a pumpable mass which is sensitive to shear forces for forming baked products preferably comprises the following steps:

the mass is conveyed by a pump apparatus into a pump outlet region wherein the volume flow of the mass in the pump outlet region has a velocity profile,
the volume flow of the mass is then divided into a plurality of partial volume flows in a dividing region,
wherein all the partial volume flows are the same size,
wherein the bodies are placed adjacent to one another at a distance on a moving transport surface,
and wherein the outlet velocities of all the emerging bodies are the same.

The method according to the invention can also be characterized in that the velocity profiles of all the partial mass flows in the dividing region and/or in the dividing openings are the same, that the shear forces acting on the mass in the dividing channels are substantially the same in each dividing channel, that the partial volume flows of the mass are reduced continuously or in sections from the cross-sectional area of the dividing openings to the cross-sectional area of the mass outlet openings and/or that the partial volume flows of the mass are conveyed through the outlet openings and then guided in the form of free jets due to gravity in the direction of the transport surface.

In order to solve the objects according to the invention and the conflict of aims described, the invention comprises a series of technical features which, when taken together, produce a synergy effect, namely that the quality of the strip-shaped bodies and the baked products formed there from can be improved, that this improvement is achieved regardless of fluctuations in the dough consistency and that at the same time the apparatus is simple in structure and maintenance-friendly.

In order to explain the invention, it is necessary to consider the flow conditions in the apparatus according to the invention. According to the invention, a mass is conveyed from a pump apparatus into a pump outlet region. Examples for pump apparatuses are, for example, screw extruders, double extruders, gear pumps, toothed roller pumps etc. These have in common that the mass is conveyed into a pump outlet region. The cross-sectional area of the pump outlet region preferably has a compact shape. Thus, preferably the greatest width of the cross-sectional area is a maximum of four times as large as the smallest width of the cross-sectional area. In the pump outlet region the mass has a certain velocity. However this velocity is not constant over the cross-sectional area of the pump outlet region. On the contrary, the volume flow of the mass has a certain velocity profile. Usually the velocities at the edge of the flow are lower due to friction at the walls. The maximum flow rate is usually in the central region of the cross-sectional area of the pump outlet region. In particular the region of maximum velocity of the volume flow lies in the region of the centre of gravity of the cross-sectional area in the pump outlet region. In the case of annular cross-sectional areas however, the maximum velocity can also occur along a circle. Since some pump apparatuses such as, for example, extruders do not have a 100% constant velocity profile in the immediate vicinity of the screw, a time-averaged velocity profile is designated as velocity profile in the sense of the invention, in particular a velocity profile averaged over a plurality of revolutions of the conveying means of the pump apparatus.

In order to improve the construction, it is proposed according to the invention to provide a plurality of outlet openings per pump apparatus. To this end, the volume flow of the mass is divided into a plurality of partial volume flows in a dividing region. In order to obtain high-quality strip-shaped bodies, all the partial streams must have the same partial volume flow. Furthermore all the shear forces which act on the conveyed mass must also be substantially the same in each partial volume flow. To this end it is necessary that in particular all the partial volume flows have substantially the same velocity profiles. In order to be able to achieve this over a best possible range of different viscosities of masses, according to the present invention the velocity profile in the pump outlet region is divided into equal parts by dividing elements. Usually a symmetrical, in particular rotationally symmetrical or radially symmetrical velocity profile is provided. This velocity profile is in particular dependent on the shape of the pump outlet channel or the cross-sectional area in the pump outlet region. Usually however a type of parabolic velocity profile is formed. In order to now obtain constant, equal partial volume flows, dividing elements are provided which are disposed in such a manner that the same regions of the volume flow and/or the velocity profile are branched off. In particular, the dividing elements are disposed radially symmetrically and/or point symmetrically about the centre of gravity of the cross-sectional area of the dividing region. Furthermore, the dividing elements can also be disposed along axes of symmetry of the cross-sectional area of the dividing region.

In the case of a round pump outlet region such as, for example, in a simple extruder, the downstream dividing region is, for example, also designed to be round. The averaged velocity profile corresponds substantially to a parabola. In order to divide into equal velocity profiles, the dividing elements are distributed along axes of symmetry and/or symmetrically in the cross-sectional area of the dividing region. Interposed dividing openings are formed by the dividing elements. These dividing openings are connected to dividing channels which extend further as far as mass outlet openings. Advantageously all the dividing openings have the same area.

In order to solve the objects according to the invention, the dividing channels and the dividing elements must be formed in such a manner that the strip-shaped bodies have uniform quality. To this end, on the one hand all the dividing channels must have substantially the same shape and the same length. On the other hand, the dividing elements must be configured in such a manner that the shear forces during the deflection or division of the mass and/or volume flow of the mass must be substantially the same.

To this end, the partial volume flows are conveyed further approximately rectilinearly following the conveying direction of the pump apparatus. In the case of a symmetrical arrangement of the dividing elements and a substantially rectilinear further guidance of the partial volume flows and the same configuration of all the dividing channels, this results in outlet openings arranged substantially along a circle. However, the outlet openings need not be arranged along a circle in order to solve the objects according to the invention.

However, according to the object of the invention it is necessary that the strip-shaped bodies are placed adjacently to one another on a moving transport surface. To this end it is now necessary that the outlet openings in the transverse direction of the transport surface have a distance from one another. Consequently the outlet openings have no overlap in the perpendicular direction. The strip-shaped bodies emerge substantially as a free jet from the outlet openings and are guided by the force of gravity in the direction of the moving transport surface. The force of gravity can, for example, act normally to the transport surface. However, a certain inclination of the transport surface is also possible. If contact is made with the transport surface, the strip-shaped bodies which have a certain viscosity are also influenced by the conveying speed of the transport surface. Preferably the individual strip-shaped bodies which are formed from the individual partial volume flows have a substantially constant division on the transport surface and/or the individual bodies have a distance from one another on the transport surface.

For this purpose the mass outlet openings are disposed adjacent to one another in the transverse direction of the transport surface. This does not necessarily mean that the mass outlet openings are disposed along a straight line. Thus, in addition to the lateral spacing in the transverse direction of the transport surface, a spacing of the outlet openings normal to the transport surface, in particular in the direction of the force of gravity can be provided. For example, the mass outlet openings can be disposed offset along a circle in such a manner so that the strip-shaped bodies placed on the transport surface have a certain distance and/or a certain division. In other words the mass outlet openings are disposed in such a manner that they have no overlap in the direction of gravity.

Subsequently the elongate strip-shaped bodies placed at a distance from one another on the transport surface are further processed. Further processing steps can, for example, be: cutting to a desired length, spraying with substances such as, for example, salt solutions etc., passing through a salt solution bath, sprinkling with scattering material such as, for example, cereals, salt or spices and/or embossing to form the strip-shaped bodies.

Further the bodies are baked in a baking oven. To this end it is advantageous if the outlet velocity of the strip-shaped bodies substantially corresponds to the speed of the baking belt of the baking oven. Furthermore it is advantageous if the baking oven has a control unit which is coupled and/or synchronized with the control unit of the apparatus according to the invention or the arrangement according to the invention. Alternatively the baking oven and the apparatus according to the invention or the arrangement according to the invention have a single control unit. Preferably a synchronization of the conveying speeds in the baking oven with the conveying speed of the apparatus according to the invention is provided.

According to an optional embodiment of the invention, rotary nozzles can be provided in the region of the mass outlet openings. These rotary nozzles preferably have mass outlet openings with cross-sectional areas which differ from a circular shape. By rotating the mass outlet openings, for example, helical, spiral or coiled serpentine-shaped bodies are produced. In principle however the same parameters with regard to the flow conditions and the same means for solving the objects according to the invention also apply for this embodiment. In particular, substantially the same flow conditions are present in each individual mass outlet region and/or in each individual rotated mass outlet opening.

The invention is described further with reference to specific exemplary embodiments.

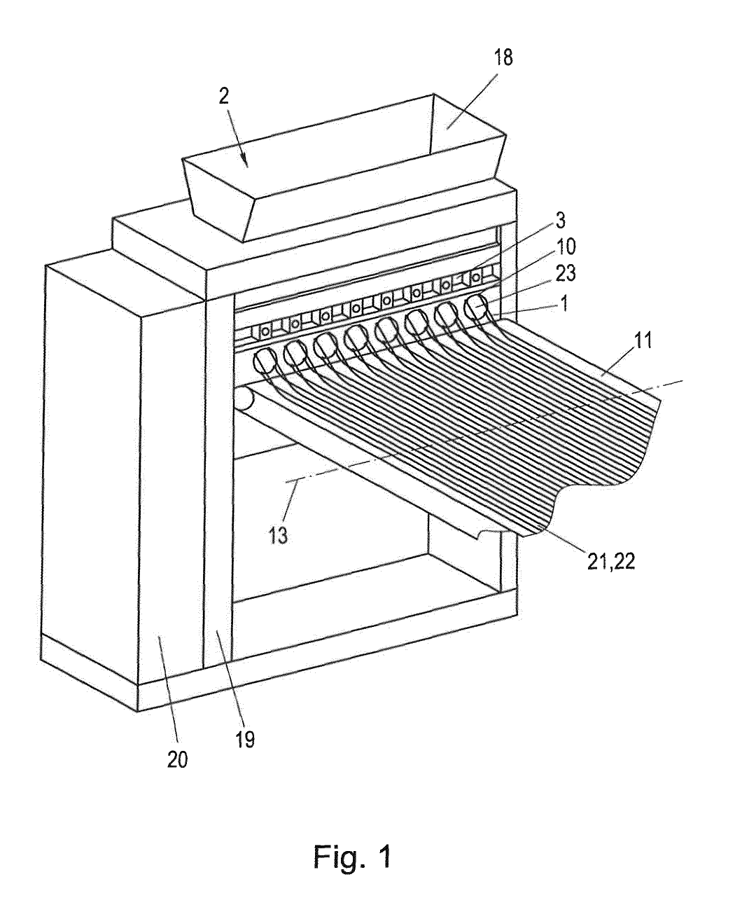

FIG. 1 shows an oblique view of an apparatus according to the invention and an arrangement according to the invention, where parts of the baking system according to the invention are cut away or nor shown.

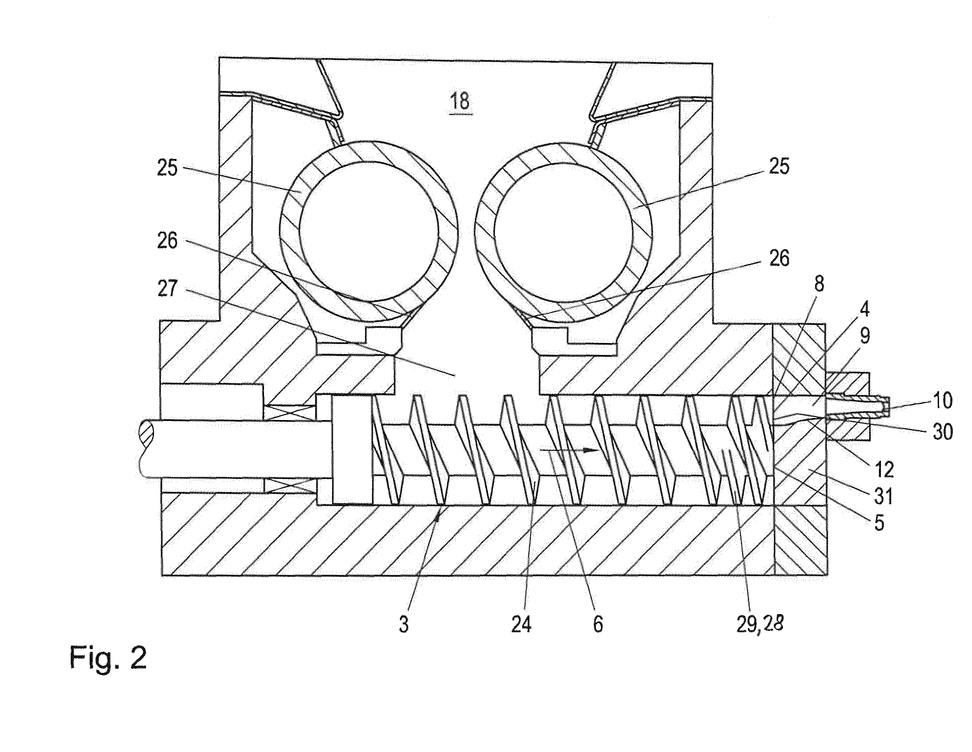

FIG. 2 shows a schematic sectional view of a possible embodiment of the apparatus according to the invention.

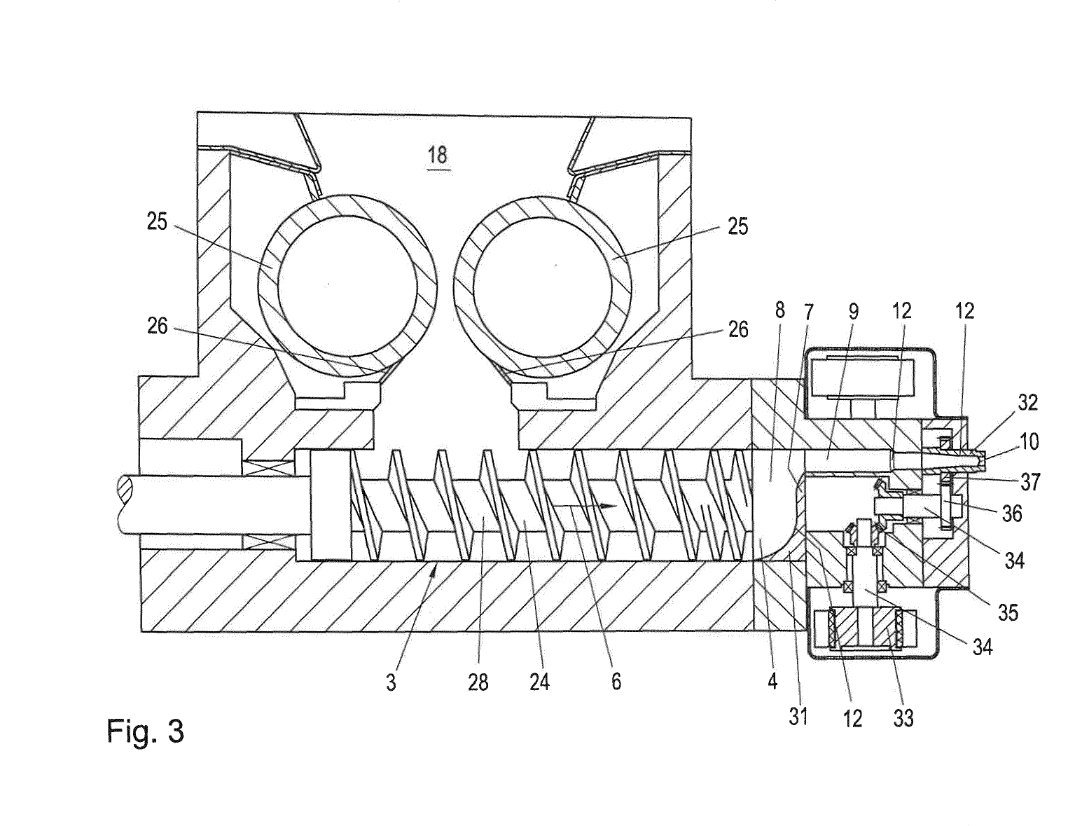

FIG. 3 shows a further embodiment of an apparatus according to the invention.

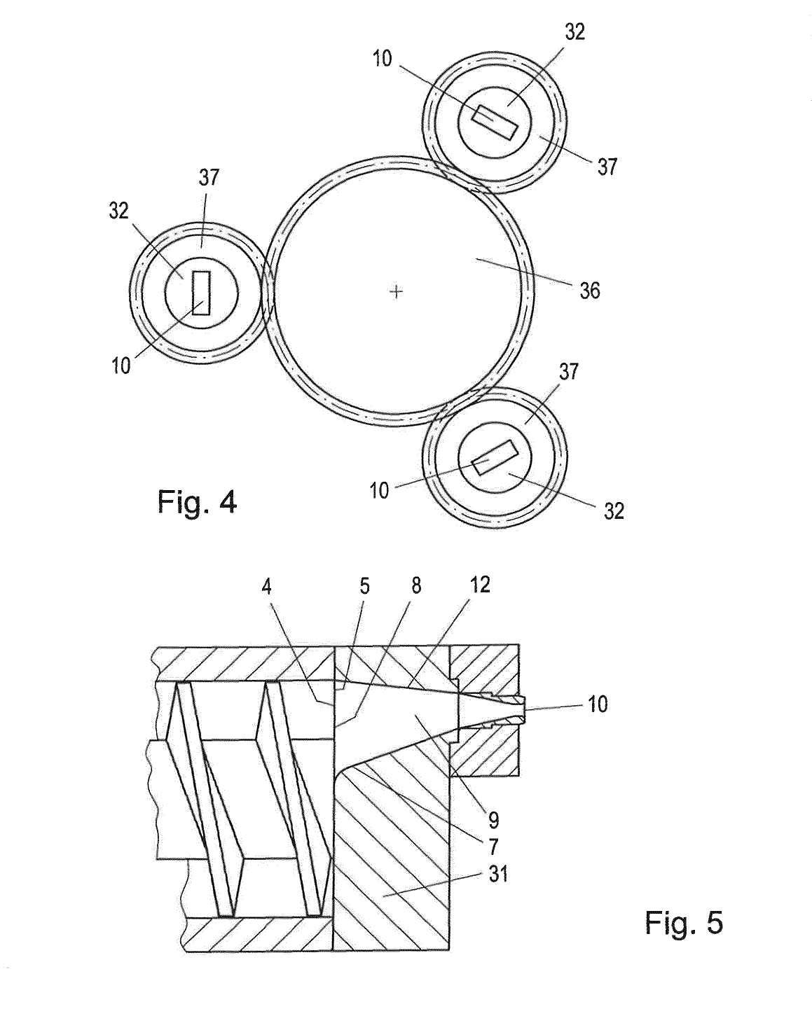

FIG. 4 shows a schematic view of a rotary nozzle arrangement.

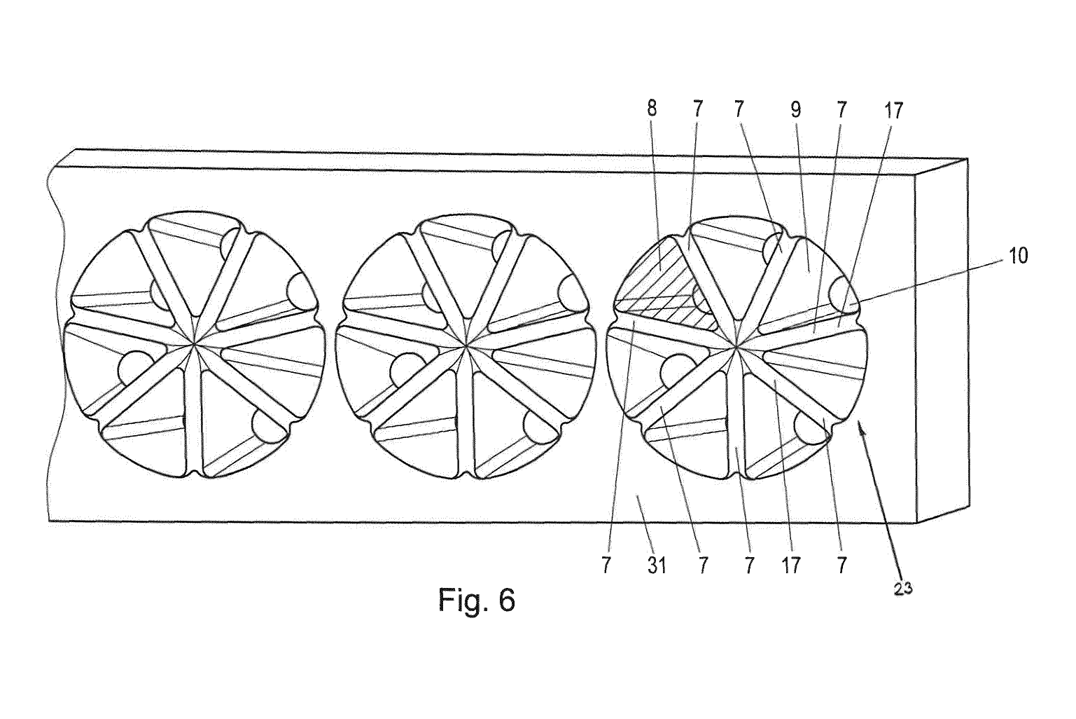

FIG. 5 shows a detail of an embodiment of an apparatus according to the invention.

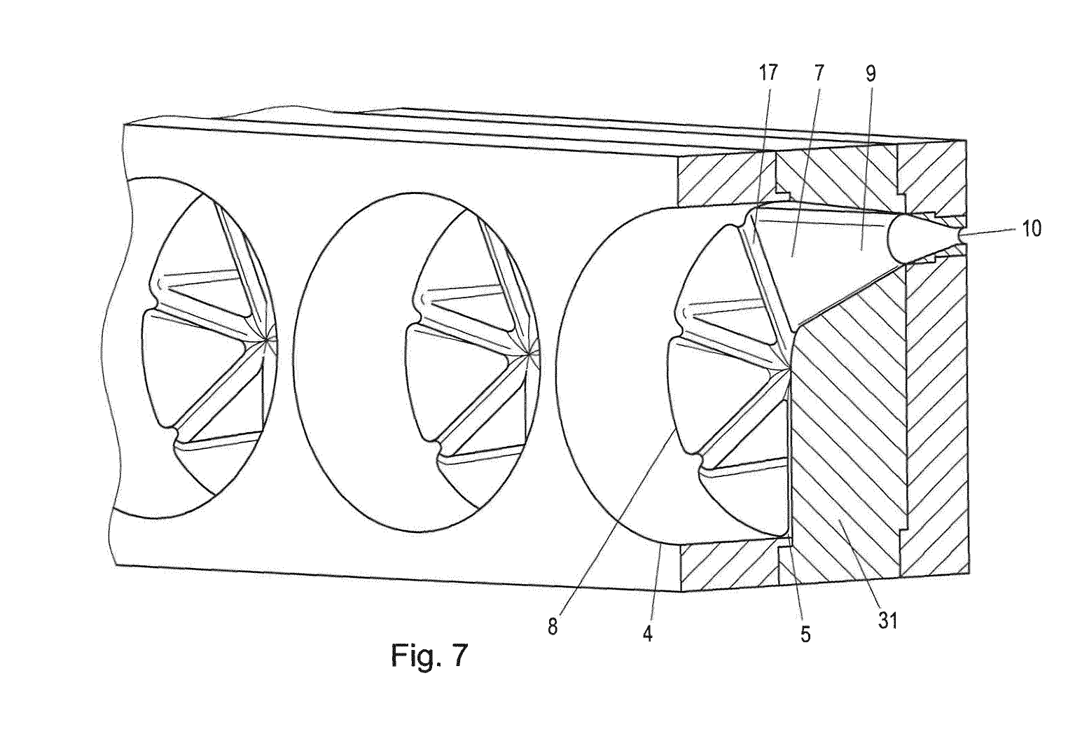

FIG. 6 shows an oblique view of a possible embodiment of the dividing elements.

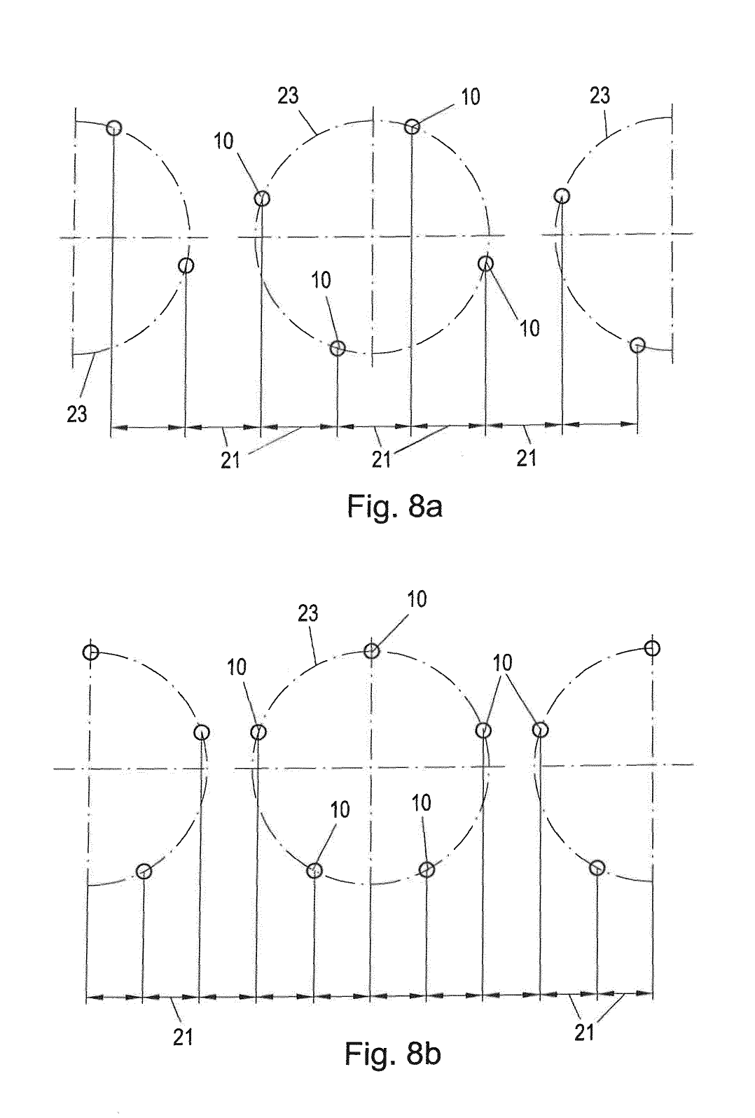

FIG. 7 shows an oblique view with partial sectional view of an embodiment according to the invention of a detail of the apparatus.

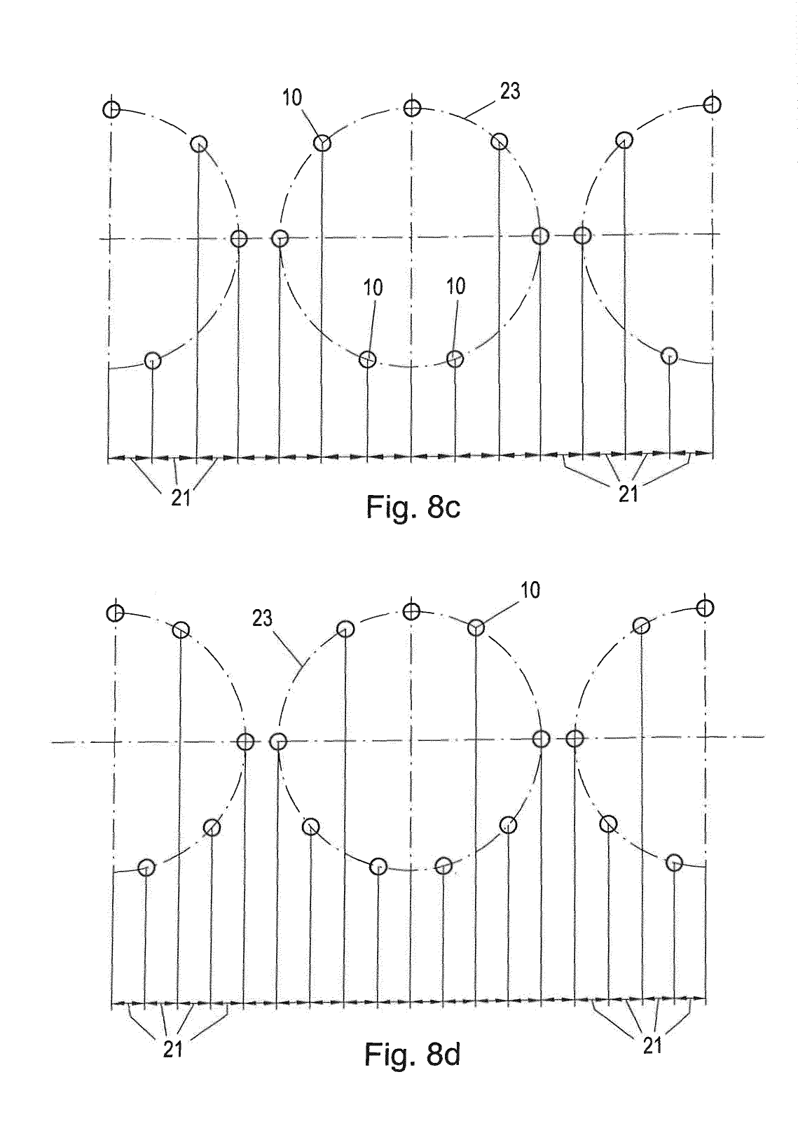

FIG. 8a shows a schematic view of the arrangement of outlet openings and divisions with four outlet openings.

FIG. 8b shows a schematic view of an exemplary embodiment with five outlet openings.

FIG. 8c shows an embodiment with 7 outlet openings,

FIG. 8d shows an embodiment with 9 outlet openings.

FIG. 1 shows an apparatus according to the invention and in particular an arrangement according to the invention of eight adjacently disposed apparatuses.

The apparatus or the arrangement comprises a mass container 18 for supplying and/or storing a mass 2. The arrangement further comprises a basic frame 19 as well as a transport surface 11 which in the present embodiment is designed as a belt conveyor. In this case, a conveyor belt is deflected and driven around at least two rollers. The apparatus and/or the arrangement comprises mass outlet openings 10 for the exit of the mass 2 in the form of elongate strip-shaped bodies 1.

Furthermore a control unit 20 is provided. This control unit 20 is optionally or preferably coupled to and/or synchronized with the control unit of the baking system.

The bodies 1 placed on the transport surface 11 have a certain spacing 22 or a certain division 21. These two spacing parameters will be discussed further in the descriptions of the following figures.

The mass outlet openings 10 are combined in groups 23 of mass outlet openings 10. Preferably one pump apparatus 3 is provided per group 23. In the present embodiment eight groups 23 of mass outlet openings 10 are provided.

The bodies 1 emerge substantially as a free jet from the mass outlet openings 10. Only on contact with the transport surface 11, do the bodies come to abut with another solid component of the apparatus according to the invention and the bodies 1 are transported further.

The strip-shaped bodies have a certain division 21 and a certain spacing 22 with respect to one another. This spacing is defined as the distance in the transverse direction 13 of the transport surface 11. The transport surface has a conveying direction which substantially corresponds to the depicted profile of the strip-shaped body 1. The transverse direction 13 is defined as normal to this direction and parallel to the transport surface 11. The division or the spacing of the individual bodies 1 is in particular brought about by the positioning of the mass outlet openings 10. In order to bring about a division according to the invention and/or a spacing according to the invention, the mass outlet openings are positioned in such a manner that they have a certain spacing with respect to one another in the transverse direction 13 of the conveying surface 11 and/or have no overlap in the perpendicular direction. The perpendicular direction corresponds to the direction of gravity—in the depicted embodiment for example, a straight line which lies in the plane of the outlet openings and runs vertically.

FIG. 2 shows a schematic sectional view of an apparatus according to the invention. Depicted inter alia are the mass container 18 for storing or supplying a mass 2, two rollers 25 which are provided to convey the mass 2 from the mass container 18 in the direction of the pump apparatus 3. To this end scrapers 26 which abut against the rollers are provided. In a preferred embodiment the rollers rotate in a mirror-inverted manner so that the direction of movement on the mutually facing sides of the rollers 25 is oriented in the direction of the pump apparatus 3. As a result, the mass 2 is entrained from the mass container 18 and scraped on the scrapers 26. Further the apparatus comprises a feed opening 27 for supplying the mass 2 into the pump apparatus 3. The pump apparatus 3 comprises conveying means 24. These conveying means 24 are adapted to convey the mass 2 in the flow direction 6 and optionally to compress it.

In the present embodiment the pump apparatus 3 is configured as an extruder. To this end an extruder screw 28 is provided which is adapted to convey the mass 2 by a rotation about the longitudinal axis. In the vicinity of the pump outlet region 4 the extruder screw has a compaction region 29. Furthermore the pump apparatus 3 has a cross-sectional area 30 in its pump outlet region 4. In the present embodiment the cross-sectional area 30 of the pump outlet region 4 is substantially annular. The reason for this is that the shaft of the extruder screw in the dividing region 5 is placed directly on the dividing body 31. According to the preceding description, at the dividing body 31, in particular in the dividing region, the volume flow of the mass 2 is divided into a plurality of equal partial volume flows. In the present view only one mass outlet opening 10 and only one dividing channel 9 are shown. However, according to the invention preferably a plurality of dividing openings 8, dividing channels 9 and mass outlet openings 10 are provided per pump apparatus. The dividing channel 9 comprises one or more reducing regions 12 in which the dividing channel 9 is reduced and/or decreased from the cross-section of the dividing opening 8 to the size of the mass outlet opening 10. According to the invention, the reducing region 12 or the reducing regions 12 is/are preferably designed as a steadily, continuously or running reducing channel.

FIG. 3 shows a further embodiment of an apparatus according to the invention. In this case, again a mass container 18 and two rollers 25 each having a scraper 26 are provided. Similarly to the embodiment of FIG. 2, an extruder screw 28 is provided as conveying means 24 of the pump apparatus 3. This is again adapted to convey the mass 2 in the flow direction 6.

The dividing region 5 and dividing elements 7 are provided following the pump outlet region 4, by which means dividing openings 8 and dividing channels 9 are formed. In particular, the dividing elements 7 are parts of the dividing body 31.

The dividing channel 9 has one or more reducing regions 12 in its course as far as the mass outlet opening 10. In the present embodiment rotary nozzles 32 are provided. These are driven by means of a drive wheel 33, a shaft 34, a transmission 35, another shaft 34, a sun gear 36 of a planetary transmission and a planetary gear 37 of the planetary transmission. The planetary gear 37 is rotatably driven and turns the rotary nozzle 32. As a result of the rotation, for example, helical bodies can be formed.

In the present embodiment again only one mass outlet opening 10 is provided. However, preferably a plurality of mass outlet openings are provided which however are not visible in the selected sectional view. For example, the mass outlet openings 10 are arranged along a circle about the axis of rotation of the sun gear 36 of the planetary transmission. Consequently a sun gear can bring about the rotation of a plurality of planetary gears 37 and a plurality of rotary nozzles 32.

FIG. 4 shows a schematic view of the planetary transmission containing a sun gear 36, three planetary gears 37 and three rotary nozzles 32 each having a mass outlet opening 10. In this embodiment the mass outlet openings have rectangular cross-sections. In particular, the cross-sections of the mass outlet openings 10 in rotary nozzles 32 have a shape which differs from the shape of a circle.

FIG. 5 shows a detail of the apparatus according to the invention in the pump outlet region 4. Located downstream of this region or directly following this region is the dividing region 5. A dividing body 31 is provided in the dividing region 5. This comprises dividing elements 7 by which means dividing openings 8 and a section of the dividing channels 9 are formed. Furthermore the apparatus comprises mass outlet openings 10. The dividing channels 9 or the dividing channel 9 have one or more reducing regions 12. In the present embodiment substantially one reducing region 12 is provided which extends over large parts of the dividing channel 9. In this case, the cross-sectional area of the dividing channel 9 is reduced from the size of the dividing opening 8 to the size of the mass outlet opening 10. A reduction of the cross-section which is gentle on the mass is required in particular for masses sensitive to shear forces to form baked products. This is achieved whereby the reduction takes place substantially continuously or steadily.

FIG. 6 shows a schematic view of an embodiment of a dividing body 31. The view is directed onto that side from which the mass 2 is pumped into the dividing openings 8. In the diagram of FIG. 6 three groups 23 of mass outlet openings 10 are shown. Preferably one pump apparatus 3 is provided per group 23 and per radially symmetrical dividing element arrangement. This pump apparatus 3 is faded out in the diagram.

Dividing openings 8 as well as sections of the dividing channels 9 are formed by dividing elements 7. For better identifications according to the diagram, one of the dividing openings 8 is shown hatched. The dividing opening substantially corresponds to that area which is spanned between the dividing elements 7 in the dividing region 5. The dividing elements 7 each comprises a comb 17 which is directed contrary to the flow direction of the mass. The dividing channels are configured to be substantially web-shaped. Furthermore in the present embodiment the dividing channels run radially symmetrically along axes of symmetry of the pump outlet cross-section and/or rotationally symmetrically.

According to the preceding description, all the dividing openings 8 are substantially the same size. The dividing channels 9 extend from the dividing openings 8 to the mass outlet openings 10. In the present embodiment the reducing region 12 is provided in the course of the dividing channel 9.

The embodiment shown in FIG. 6 comprises seven dividing openings 8, seven dividing channels 9 and seven mass outlet openings 10 per group 23 and/or per pump apparatus 3.

The dividing elements 7 are designed to be substantially wedge-shaped and have a comb 17 on their sides directed contrary to the flow direction. The comb 17 runs in a web shape in the dividing region so that dividing openings are formed. In order to reduce the shear forces acting on the mass, the combs 17 are preferably designed to be rounded. As a result, the dough is divided gently into partial volume flows in the dividing region. The reducing regions of the dividing channels are formed by the wedge-shaped configuration of the dividing elements 7.

FIG. 7 shows another embodiment of a detail of the apparatus according to the invention and/or the arrangement according to the invention. In this case, the dividing region 5 is located at a certain distance downstream of the pump outlet region 4. Dividing elements 7 which form dividing openings 8 and dividing channels 9 extend from the dividing region 5 in the direction of the outlet opening 10. As in the preceding description, the dividing elements 7 are designed in such a manner that they each comprise a comb 17 which is directed contrary to the flow direction of the mass 2. This comb is in particular designed to be web-shaped, preferably rounded. The dividing elements bring about a gentle division of the mass sensitive to shear forces into the individual dividing channels. Here care should be taken to ensure that the volume flow, the shear forces and the friction ratios are substantially the same in each dividing channel.

According to the embodiment of FIG. 7, the dividing body 31 is designed as an independent body which can be separated from the apparatus, in order for example to clean the dividing elements. However it is also consistent with the inventive idea, as shown in further embodiments, to configure the dividing body 31 in such a manner that this comprises the outlet openings 10, the pump outlet cross-section and the dividing cross-section.

FIG. 8a shows a schematic view of a possible positioning of the mass outlet openings 10. In the present embodiment each group 23 of mass outlet openings 10 comprises four mass outlet openings 10. These have a certain spacing and in particular a certain division 21 in the transverse direction of the transport surface. The spacing of the individual strip-shaped bodies corresponds in this case to the division minus the thickness of a body. In the present view the direction of the combining of the dividing arrows 21 corresponds to a direction which corresponds to the transverse direction 13 of the transport surface. The exit direction of the mass from the mass outlet openings 10 runs substantially in a projecting manner.

FIG. 8b shows another embodiment where five mass outlet openings 10 are provided per group 23. In this case, the mass outlet openings 10 are arranged in such a manner that they have a constant division 21 and/or a spacing in the transverse direction 13 of the transport surface.

FIG. 8c shows another embodiment of the apparatus according to the invention in a schematic view where each group 23 comprises seven mass outlet openings 10. These are arranged in such a manner that a constant division 21 and/or a constant spacing is achieved in the transverse direction 13 of the transport surface.

FIG. 8d shows another embodiment in which nine mass outlet openings 10 are provided per group 23.

The different embodiments can be combined with one another. Thus, it is consistent with the inventive idea to provide one, two, three, four, five, six, seven, eight, nine, ten, eleven, twelve, thirteen or more mass outlet openings per pump apparatus 3 and/or per group 23. In this case, care should be taken to ensure that the outlet openings 10 have no overlap in the perpendicular direction and/or that the emerging strip-shaped bodies have a certain spacing and/or a certain division on the transport surface. To this end, the outlet openings can be provided along a circle. Furthermore, the mass outlet openings can however also be arbitrarily positioned with the restriction that they either have no overlap in the perpendicular direction or that the bodies placed on the transport surface have a certain spacing with respect to one another. Furthermore it is extremely important according to the invention that the volume flows of the masses and/or bodies emerging through the individual mass outlet openings 10 are the same.

Combinations of different embodiments are also possible. Thus, both embodiments of FIG. 2 and FIG. 3 can comprise dividing bodies according to FIG. 5, FIG. 6 or FIG. 7. The dividing bodies of FIGS. 5, 6 and 7 can in this case comprise arrangements of the mass outlet openings according to FIGS. 8a, 8b, 8c and 8d as well as further positioning according to the invention. In all embodiments the mass emerges from the mass outlet openings preferably substantially horizontally. Also in all embodiments the extruder screw is preferably located substantially horizontally.

### REFERENCE LIST

1 Body
2 Mass
3 Pump apparatus
4 Pump outlet region
5 Dividing region
6 Flow direction
7 Dividing elements
8 Dividing opening
9 Dividing channel
10 Mass outlet opening
11 Transport surface
12 Reducing region
13 Transverse direction (of the transport surface)
14 Centre of gravity
15 Cross-sectional area (of the dividing region)
16 Axis of symmetry
17 Comb
18 Mass container
19 Basic frame
20 Control unit
21 Division
22 Spacing
23 Group of mass outlet openings
24 Conveying means of pump apparatus
25 Roller
26 Scraper
27 Feed opening into the pump apparatus
28 Extruder screw
29 Compaction region
30 Cross-sectional area
31 Dividing body
32 Rotary nozzle
33 Drive wheel
34 Shaft
35 Transmission
36 Sun gear
37 Planetary gear

1-18. (canceled)

19. An apparatus for forming elongate strip-shaped bodies of a pumpable mass which is sensitive to shear forces for forming baked products, the apparatus comprising:
a pump apparatus for conveying the mass into a pump outlet;
a dividing section disposed downstream of said pump outlet in a product flow direction, said dividing section having a plurality of dividing openings delimited by dividing elements;
a plurality of individual dividing channels separated from each other and leading from said dividing openings to respective mass outlet openings;
a moving transport surface disposed for transporting strip-shaped bodies emerging from said mass outlet openings;
said dividing channels having a continuously running-together reducing region and said mass outlet openings being spaced from one another in a transverse direction of said transport surface; and
said dividing elements including combs directed counter to the product flow direction of the mass and being rounded in a direction counter to the flow direction.

20. The apparatus according to claim 19, wherein one or more of the following is true:
said dividing elements are disposed substantially radially symmetrically about a center of gravity of a cross-sectional area of said dividing section;
said dividing elements are disposed substantially point-symmetrically about the center of gravity of the cross-sectional area of said dividing section;
said dividing elements are disposed along axes of symmetry of the cross-sectional area of said dividing section.

21. The apparatus according to claim 19, wherein all of said dividing openings in said dividing section have a common area and/or are congruent.

22. The apparatus according to claim 19, wherein said dividing elements have one or more shapes selected from the group consisting of a web shape and a wedge shape.

23. The apparatus according to claim 19, wherein one or both of the following are true: said dividing channels are configured to substantially follow a direction of flow of the mass at said pump outlet and a direction of flow of the mass in said mass outlet openings substantially corresponds to a direction of flow of the mass at said pump outlet.

24. The apparatus according to claim 19, wherein said pump apparatus is an extruder.

25. The apparatus according to claim 19, wherein said pump outlet has a substantially circular cross-section.

26. The apparatus according to claim 19, which comprises rotary nozzles disposed at said mass outlet openings or wherein said rotary nozzles form said mass outlet openings.

27. The apparatus according to claim 26, which comprises a planetary transmission configured to drive said rotary nozzles of a group of said mass outlet openings.

28. An assembly, comprising: a plurality of apparatuses according to claim 19 arranged adjacent one another along a transverse direction of the transport surface.

29. A baking system, comprising:
a heated or heatable baking chamber for baking elongate strip-shaped bodies of a pumpable mass that is sensitive to shear forces; and
at least one apparatus according to claim 19.

30. A method for producing elongate strip-shaped bodies from a pumpable mass that is sensitive to shear forces for forming baked products, the method comprising the following steps:
conveying the mass by a pump apparatus into a pump outlet region, wherein a volume flow of the mass in the pump outlet region has a velocity profile;
subsequently dividing the volume flow of the mass into a plurality of partial volume flows in a dividing section, the partial volume flows being of equal size;
placing the strip-shaped bodies adjacent one another at a spacing distance on a moving transport surface; and
setting outlet velocities of all emerging strip-shaped bodies to be equal.

31. The method according to claim 30, which comprises setting the velocity profiles of all the partial mass flows in the dividing section and/or in the dividing openings to be the same.

32. The method according to claim 30, wherein the shear forces acting on the mass in the dividing channels are substantially the same in each dividing channel.

33. The method according to claim 30, which comprises continuously reducing the partial volume flows of the mass from a cross-sectional area of the dividing openings to a cross-sectional area of the mass outlet openings.

34. The method according to claim 30, which comprises reducing the partial volume flows of the mass in sections from a cross-sectional area of the dividing openings to a cross-sectional area of the mass outlet openings.

35. The method according to claim 30, which comprises conveying the partial volume flows of the mass through the outlet openings and then guiding the flows of the mass in the form of free jets due to gravity in a direction of the transport surface.
